(19) United States
(12) Patent Application Publication
(10) Pub. No.: US 2006/0139130 A1
(43) Pub. Date: Jun. 29, 2006

(54) HARMONIC REJECTION TUNER

(76) Inventor: Philippe Boulerne, Montreal (CA)

Correspondence Address: BOULERNE PHILIPPE, 6980 LACROIX, VILLE-EMARD, MONTREAL, QC, H4E 2V3, CA

(21) Appl. No.: 11/023,089

(22) Filed: Dec. 28, 2004

(51) Int. Cl. H01P 5/04

(52) U.S. Cl. 333/263

(57) ABSTRACT

The present invention discloses a harmonic rejection tuner system consisting of a radio-frequency (RF) or microwave transmission line having a longitudinal axis, containing at least one harmonic resonator sliding on the central conductor, said harmonic resonator is a pair of shorted-stubs, said shorts are adjustable, making the electromagnetic length of the shunt shorted-stubs variable, therefore making the resonant frequency of the harmonic resonator variable. The harmonic resonator will reflect a harmonic frequency nF0 of a base frequency F0. The harmonic rejection tuner of this invention has an input and output, and is connected in series between the DUT and the large band fundamental tuner.

### CROSS REFERENCE TO RELATED APPLICATIONS

U.S. Patent Documents

U.S. Pat. No. 6,297,649 Oct. 2, 2001 Tsironis 324/642

U.S. Pat. No. 6,674,293 Jan. 6, 2004 Tsironis 324/638

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to an electromechanical harmonic rejection tuner system, and more particularly to such a system to be used in harmonic load-pull setup for the measurement, characterization and testing of RF or microwave devices. Under high power conditions at its input at the fundamental frequency F0, the device under test (hereinafter referred to as “DUT”) generates an output signal that contains the fundamental frequency F0 and the harmonic frequencies of said fundamental frequency F0. RF/Microwave harmonic rejection tuners are electronic devices or mechanical devices which modify in a predictable way the phase of the reflection of harmonics of a given operation frequency F0. The harmonic rejection tuner has the capability of generating high amplitude gamma to the microwave devices at harmonic frequencies. This technique of subjecting DUT input and output to variable high gamma phase with corresponding harmonic source tuner and harmonic load tuner, commonly referred to as “harmonic load pull”, is used to test transistors for amplifier, oscillator or frequency multiplier applications specially at high power, when the non-linear effects of the DUT produces harmonic frequencies.

2. Description of Prior Art

The harmonic load-pull setup is composed of an input generator and its associated amplification (1) connected to input fundamental tuner (2), input harmonic tuner (3), DUT (4), output harmonic tuner (5), output fundamental tuner (6) and the appropriated measurement apparatus (7).

One possible configuration for the harmonic tuner has been proposed in U.S. Pat. No. 6,297,649 issued to Christos TSIRONIS Oct. 2, 2001. These harmonic tuners are comprising a transmission line (9) on which 2 open-stubs (11,12) are sliding on the central conductor (10), which open-stubs are surrounded by a circular side wall (14,14′) and permanently secured on the said side walls through dielectric, low loss washers (13,13′). The open-stubs are then positioned along the transmission line to control the phase of the reflection as indicated by arrows (11″) and (12″). In order to eliminate the residual reflection at the fundamental frequency F0, additional open-stubs (11′,12′) might be added, said additional open-stubs are identical to the first open-stubs (11,12).

The problem remaining with this solution is that when the fundamental frequency F0 changes, the length of each of the open-stubs should be changed to reflect out the desired harmonic frequencies of the new fundamental frequency F0. Therefore, the harmonic rejection load-pull tuner of U.S. Pat. No. 6,297,649 is supplied as a kit with a plurality of open-stubs. Each open-stub is having a length adapted to reflect out an nth order harmonic nF0 of a given frequency F0. In order to solve that problem, U.S. Pat. No. 6,297,649 exposes the possibility of using open-stubs having a variable length to increase Δf. Plungers (100) can be used in order to make the open-stubs lengths (18,19) variables. This will however be accompanied by a decrease in the precision of the measurements, because of the difficulty in precisely adjusting the position of the plunger with the screw. Another drawback of open-stub plungers is that the characteristic impedance of the open-stub (18,19), defined by arrow (101), is different from the characteristic impedance of the plungers (100), defined by arrow (102), since the distances from the open-stubs and the plungers to the grounding walls (14,14′) is necessarily different.

### BRIEF SUMMARY OF THE INVENTION

The problem remaining in the prior art has been solved in accordance with the present invention which relates to a class of mechanical harmonic rejection load-pull tuner comprising a transmission line, two harmonic resonators sliding along the transmission line longitudinal axis, which harmonic resonators are shunt shorted-stubs, said shorts are moveable along the stub, making the rejection frequencies adjustable.

### BRIEF DESCRIPTION OF THE SEVERAL VIEWS OF THE DRAWING

FIG. 1: Prior Art: depicts a schematic block diagram of a harmonic load-pull setup using harmonic tuners in series between the fundamental tuners and the DUT

FIG. 2A: Prior Art: depicts a double harmonic tuner with open-stubs

FIG. 2B: Prior Art: depicts a double harmonic tuner with open-stubs—longitudinal cross sectional view.

FIG. 2C: Prior Art: depicts a double harmonic tuner with open-stubs—transversal cross sectional view.

FIG. 2D: Prior Art: depicts a double harmonic tuner with open-stubs—schematic longitudinal cross sectional view.

FIG. 3A: Prior Art: depicts a double harmonic tuner with pair of open-stubs

FIG. 3B: Prior Art: depicts a double harmonic tuner pair of open-stubs—longitudinal cross sectional view.

FIG. 3C: Prior Art: depicts a double harmonic tuner with pair of open-stubs—transversal cross sectional view.

FIG. 3D: Prior Art: depicts a double harmonic tuner with pair of open-stubs—schematic longitudinal cross sectional view.

FIG. 4A: Prior Art: Depicts a double harmonic tuner with open-stubs with plungers.

FIG. 4B: Prior Art: Depicts a double harmonic tuner with pair of open-stubs with plungers.

FIG. 5A: Depicts a double harmonic tuner with shorted-stubs.

FIG. 5B: Depicts a double harmonic tuner with pair of shorted-stubs.

FIG. 6: Depicts a harmonic rejection tuner arrangement—perspective view.

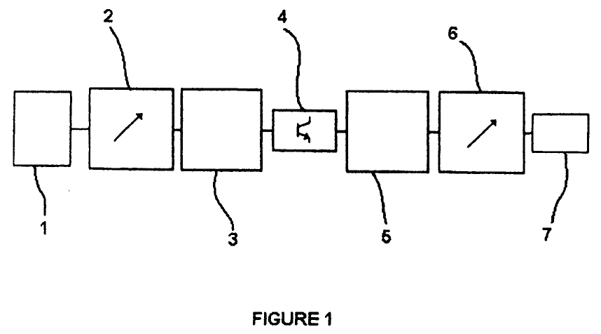

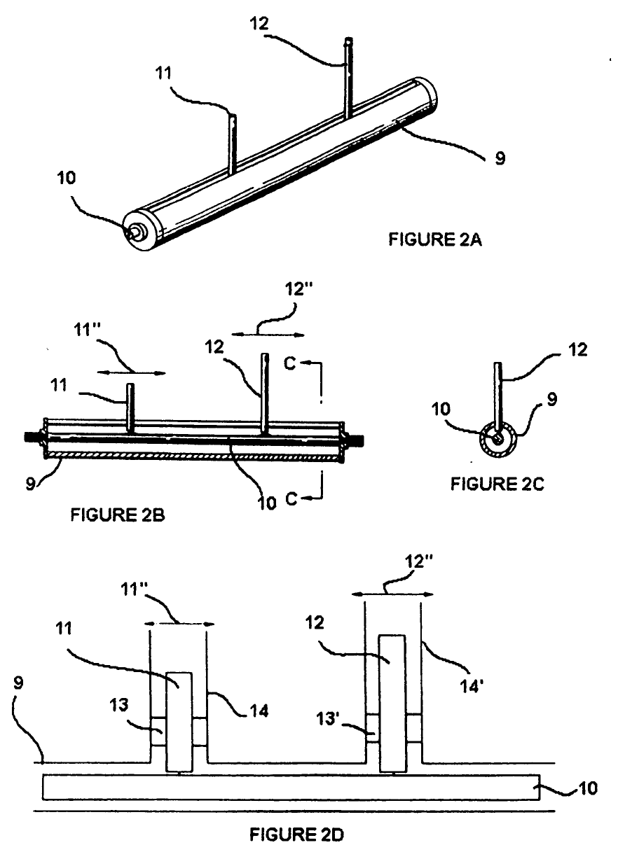

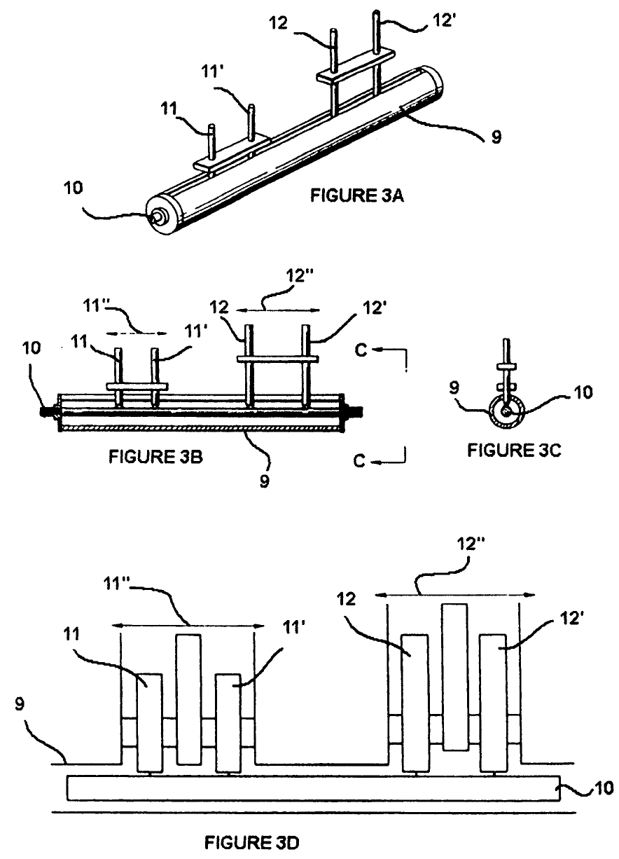

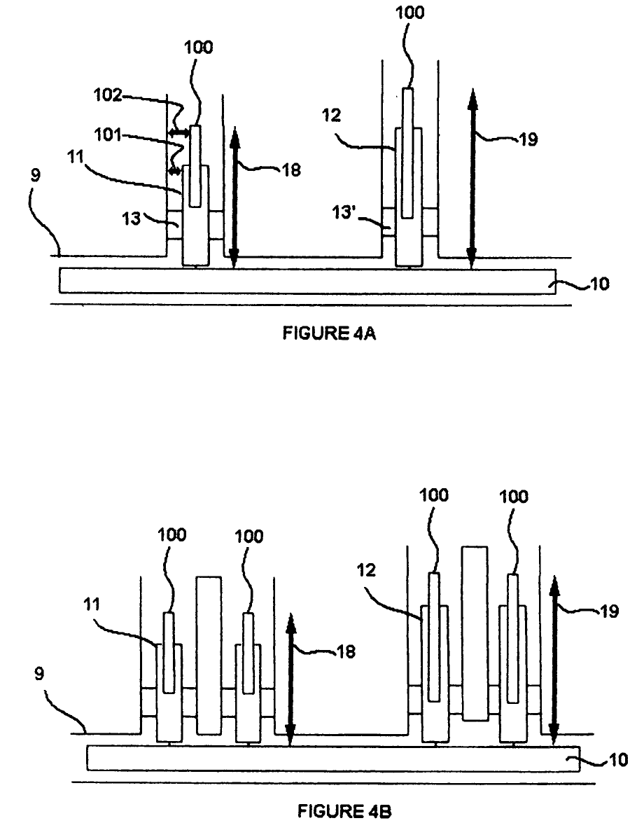

### DETAILED DESCRIPTION OF THE INVENTION

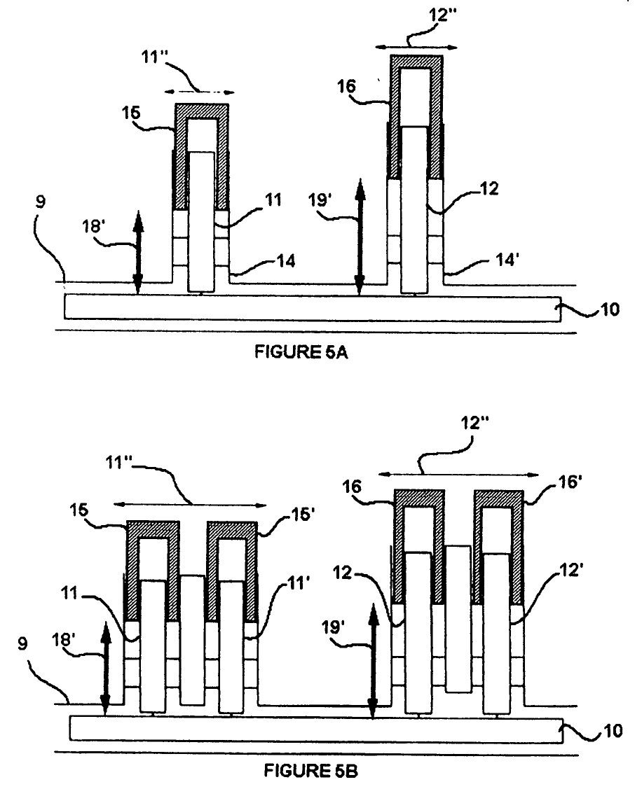

Referring to FIGS. 5A and 5B, the harmonic rejection tuner from this invention reflects back to DUT at least one of the harmonic frequencies nF0 of a fundamental frequency F0 with appropriate phase angle, said harmonic frequencies being adjustable with changes of F0.

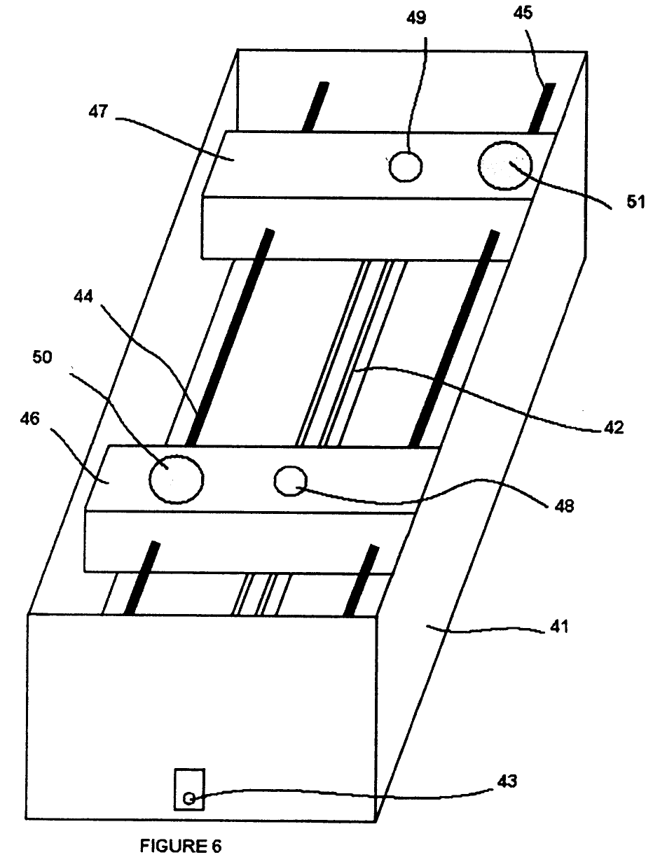

The harmonic rejection tuner, described by FIGS. 5A, 5B and 6, consists of a housing (41), a transmission line (9,42) with a characteristic impedance Z0. The transmission line contains two harmonic resonators (11,12,48,49), that slide between the inner (10,43) and outer (9) conductors. In a preferred embodiment of this invention, the harmonic resonators (11,12) include a pair of coaxial resonators, each resonator being mechanically linked to a mobile carriage (46,47). The harmonic resonators are horizontally positioned in the transmission line by mobile carriages (46,47), which are driven by two lateral mechanisms such as driving screws (44,45), which themselves are controlled by stepping motors (50,51). Both harmonic resonators are sliding on the central conductor of the transmission line as depicted by arrows (11″,12″).

The harmonic resonators of this invention are shunt shorted-stubs, with a characteristic impedance half of the characteristic impedance of the transmission line (9,42). The electromagnetic-length of the shorted-stubs, depicted by arrows (18′) and (19′), will determine the resonant frequency being rejected by the resonators. Appropriate means (15,16) to short the stubs (11,12) are provided. Perfect galvanic contact of the shorting means (15,16) has to be accomplished with both the shunt stubs (11,12) and the outer conductor (14,14′). In a preferred embodiment of this invention, the resonators are coaxial resonators, allowing the shorting means (15,16) to slide between the shunt stubs (11,12) and the outer conductor (14,14′), making the electromagnetic-length of the shunt stubs variable as depicted by arrows (18′,19′). By varying the electromagnetic-length of the stubs (11,12) with the shorting means (15,16), the user can change the harmonic resonant frequency accordingly to any change of the fundamental frequency F0. The characteristic impedance of the shorted-stubs will stay constant when changing the electromagnetic-length (18′,19′).

In order to control the phase angle of the reflection, the harmonic resonators are moveable along the longitudinal axis of the transmission line (10,43), as shown by arrows (11″) and (12″). An appropriate motor driven mechanism (50,51) ensures the controlled smooth travel of the harmonic resonators (11,12,11′,12′) along the longitudinal axis of the transmission line (10,43) and thus the control of the phase reflection generated by the harmonic resonators. Afterwards, large band tuning can be performed, without having any impacts from the harmonic frequencies.

In a second preferred embodiment of this invention, identical shorted-stubs (11′,12′) to their corresponding shorted-stubs (11,12) are added with equal electromagnetic-length (18′,19′) arranged by shorting means (15′,16′) at a predetermined distance in order to eliminate residual unwanted reflection at the fundamental frequency F0. The said added shorted-stubs (11′) and (12′) being mechanically attached to respectively shorted-stubs (11) and (12) and are sliding on the central conductor (10,43) simultaneously.

Finally, expressions such as “equal” and “identical” have been used in the present description and in the following claims. However, it will be understood that these expressions, and other like them, are used in the context of theoretical calculations, but in practice mean “as close as possible” to the theory.

Although the present invention has been explained hereinabove by way of a preferred embodiment thereof, it should be pointed out that any modifications to this preferred embodiment within the scope of the appended claims is not deemed to alter of change the nature and scope of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

The embodiments of the invention in which an exclusive property or privilege is claimed are defined as follows:

1. A harmonic rejection load pull tuner comprising:
means for reflecting at least one harmonic frequency of a base frequency, said means having an input and an output, said input being connected to an output of a device under test (DUT) and said output being connected to the input of large-band tuner, where said means for reflecting at least one harmonic frequency comprising:
a transmission line having a longitudinal axis of characteristics impedance Z0;
and at least one shorted-stub in parallel with said transmission line, said shorted-stub having a constant characteristics impedance Z0/2, being galvanically connected to said transmission line and having a shorting mean galvanically connected to the stub and the ground in order to adapt electromagnetic length of said shorted-stub to reflect out an nth order harmonic of a base frequency, where n is an integer greater than 1.

2. A harmonic rejection load pull tuner according to claim 1, wherein said at least one shorted-stub is moveable along transmission line.

3. A harmonic rejection load pull tuner according to claim 2, wherein said means for reflecting at least one harmonic frequency include two moveable shorted-stubs, each of said shorted-stubs being in parallel with said transmission line and longitudinally spaced apart from each other, a first shorted-stub having an electromagnetic length adapted to reflect out a second order harmonic and a second shorted-stub having a electromagnetic length adapted to reflect out a third order harmonic.

4. A harmonic rejection load pull tuner according to claim 2, wherein said transmission line is a coaxial line of characteristics impedance Z0.

5. A harmonic rejection load pull tuner according to claim 2, wherein said at least one moveable shorted-stub is a coaxial resonator of characteristics impedance Z0/2.

6. A harmonic rejection load pull tuner according to claim 2, wherein at least one of said at least one moveable shorted-stub further includes another resonator adapted to compensate the effect of the corresponding moveable shorted-stub on the reflection factor at the fundamental frequency, said other resonator having a configuration identical to the corresponding moveable shorted-stub and being mechanically attached thereto.

7. A harmonic rejection source pull tuner comprising:
means for reflecting at least one harmonic frequency of a base frequency, said means having an input and an output, said input being connected to the output of large-band tuner, and said output being connected to an input of a device under test (DUT), where said means for reflecting at least one harmonic frequency comprising:
a transmission line having a longitudinal axis of characteristics impedance Z0;
and at least one shorted-stub in parallel with said transmission line, said shorted-stub having a constant characteristics impedance Z0/2, being galvanically connected to said transmission line and having a shorting mean galvanically connected to the stub and the ground in order to adapt electromagnetic length of said shorted-stub to reflect out an nth order harmonic of a base frequency, where n is an integer greater than 1.

8. A harmonic rejection source pull tuner according to claim 1, wherein said at least one shorted-stub is moveable along transmission line.

9. A harmonic rejection source pull tuner according to claim 8, wherein said means for reflecting at least one harmonic frequency include two moveable shorted-stubs, each of said shorted-stubs being in parallel with said transmission line and longitudinally spaced apart from each other, a first shorted-stub having an electromagnetic length adapted to reflect out a second order harmonic and a second shorted-stub having an electromagnetic length adapted to reflect out a third order harmonic.

10. A harmonic rejection source pull tuner according to claim 9, wherein said transmission line is a coaxial line of characteristics impedance Z0.

11. A harmonic rejection source pull tuner according to claim 9, wherein said at least one moveable shorted-stub is a coaxial resonator of characteristics impedance Z0/2.

12. A harmonic rejection source pull tuner according to claim 9, wherein at least one of said at least one moveable shorted-stub further includes another resonator adapted to compensate the effect of the corresponding moveable shorted-stub on the reflection factor at the fundamental frequency, said other resonator having a configuration identical to the corresponding moveable shorted-stub and being mechanically attached thereto.
